(19) United States
(12) Patent Application Publication
(10) Pub. No.: US 2007/0157112 A1
(43) Pub. Date: Jul. 5, 2007

(54) On-demand scrollbar

(76) Inventor: Johan C. Peters, St. Leon-Rot (DE)

Correspondence Address: KENYON & KENYON LLP, 1500 K STREET N.W., WASHINGTON, DC, 20005, US

(21) Appl. No.: 11/322,076

(22) Filed: Dec. 30, 2005

(51) Int. Cl. G06F 9/00; G06F 17/00

(52) U.S. Cl. 715/786; 715/784; 715/772

(57) ABSTRACT

Embodiments of the present invention relate to an on-demand scrollbar for electronic documents. The scrollbar may comprise a plurality of indicators respectively corresponding to portions of an electronic document. In response to selection of an indicator, a download of a corresponding document portion may be initiated. Thus, a user is able to more quickly access information of interest, as opposed to having to wait for an entire document to be downloaded before accessing information of interest.

### BACKGROUND OF THE INVENTION

Most computer users are familiar with the lag that can occur between the time information is requested for display, and the time the information is actually displayed. Such lags may be due to a number of factors. In a network environment, for example, because of traffic, network latencies, contention for resources, high data volumes and other things, it can take time for information requested from a server to be downloaded to a client for display. This delay can be frustrating for users.

While a certain amount of delay may be unavoidable, frustration may be aggravated when, for example, a user is interested in only particular portions of a data file but must wait for the entire data file to be downloaded before the portions of interest may be viewed.

### BRIEF DESCRIPTION OF THE DRAWINGS

FIGS. 1-3 show an on-demand scrollbar according to embodiments of the present invention;

FIG. 4 shows a computer system according to embodiments of the present invention; and

FIG. 5 shows a process flow according to embodiments of the present invention.

### DETAILED DESCRIPTION

Embodiments of the present invention relate to an on-demand scrollbar for use in computer displays that addresses the concerns discussed above. According to the embodiments, the scrollbar may be included in an electronic display of a document that contains multiple parts. The scrollbar may contain indicators corresponding to respective parts of the document. By activating an indicator, a user may select a corresponding part of the document to download. Thus, a user is able to more quickly access information of interest, as opposed to having to wait for an entire document to be downloaded before accessing information of interest.

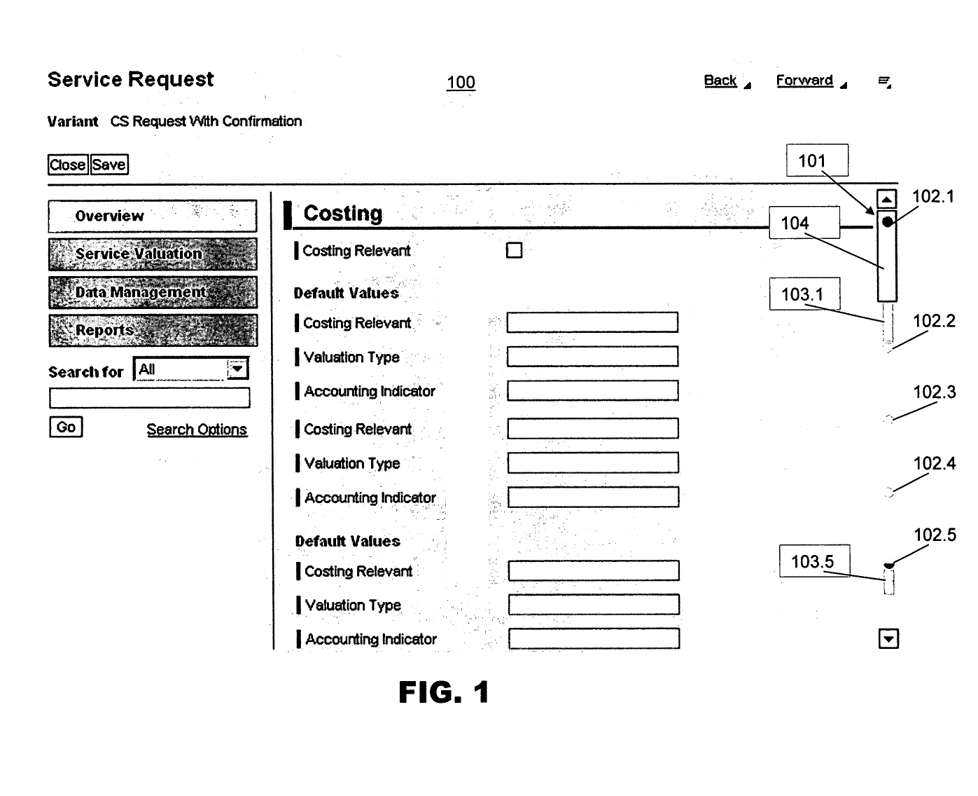

FIG. 1 shows an example of a scrollbar 101 according to embodiments of the present invention. The scrollbar 101 may be incorporated into a computer display 100. The scrollbar 101 may comprise a plurality of indicators 102.1, 102.2, . . . , 102.n. Each indicator 102.1, 102.2, . . . , 102.n may correspond to a portion of an electronic document. Each indicator 102.1, 102.2, . . . , 102.n may further be associated with a corresponding download status field. The download status field may not become visible until a download is activated. In FIG. 1, indicators 102.1 and 102.5 have associated download status fields 103.1 and 103.5 respectively, while indicators 102.2, 102.3 and 102.4 do not yet have visible associated download status fields. The scrollbar 101 may further include a sliding or displaceable scrolling button 104.

Each indicator 102.1, 102.2, . . . , 102.n and download status field 103.1, 103.2, . . . , 103.n may show the progress of a download of a corresponding portion of a document. For example, in FIG. 1, indicator 102.1 is completely filled in with a dark color, and download status field 103.1 extends completely from indicator 102.1 to indicator 102.2. This shows that the portion of the document corresponding to indicator 102.1 and download status field 103.1 is completely downloaded. If a user wanted to, he or she could immediately display the information contained in this portion without waiting for other portions to download.

Indicators 102.2, 102.3 and 102.4, on the other hand, remain completely filled in with a light color, and there is no visible download status field associated with them. This means that no download has yet been initiated for the document portions associated with these indicators.

Indicator 102.5 shows that download has been initiated for the corresponding document portion, and that the download is in progress. This shown by the fact that the indicator 102.5 is partly light-colored and partly dark-colored. The corresponding status field 103.5 shows, by the dark-colored portion extending downward from the indicator 102.5, that the download of the corresponding document portion is about half complete.

Download of a document portion may be initiated, for example, by clicking on an indicator with an input device such as a mouse. Alternatively, to select an indicator, the user may drag the scrolling button 104 to the indicator. Further, a download in progress may be stopped, for example, by clicking on a corresponding indicator. The download may then be resumed at the point it left off by clicking again on the corresponding indicator.

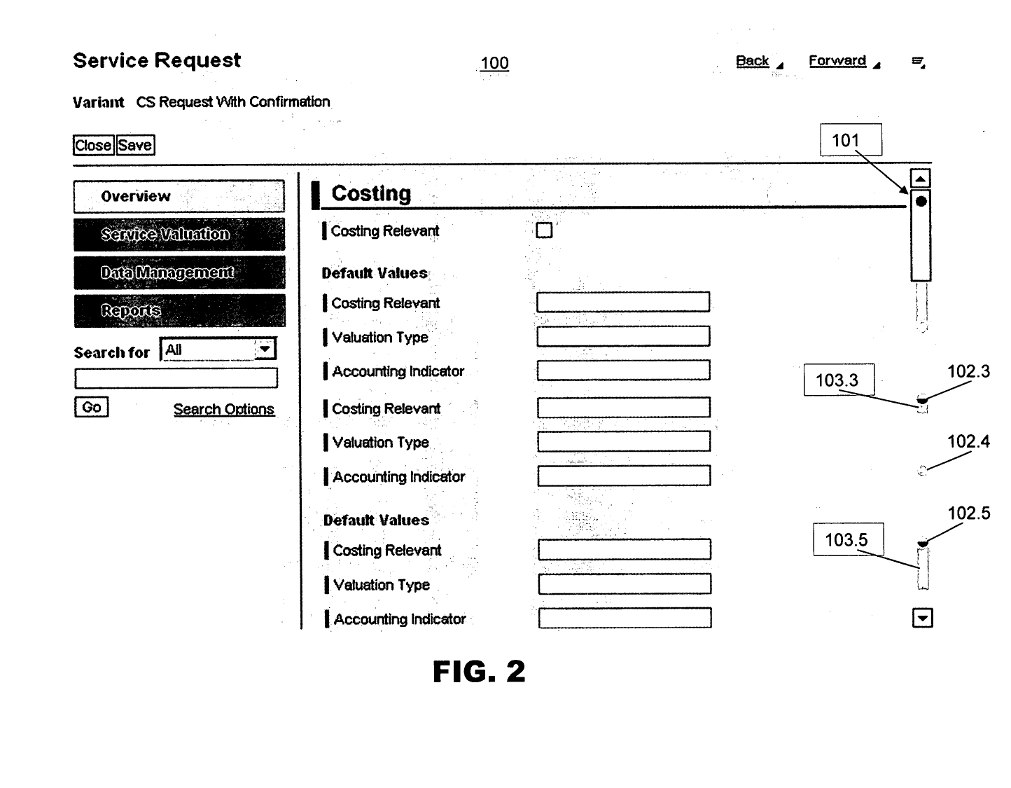

FIG. 2 shows the scrollbar 101 with indicator 102.3 having been selected or activated by an input device. In comparison to its appearance in FIG. 1 where it is fully light-colored, in FIG. 2 indicator 102.3 is partly light-colored partly and dark-colored, showing that download is in progress for the corresponding document section. A download status field 103.3 has appeared and begun to extend downward toward neighboring indicator 102.4. FIG. 2 further shows that status field 103.5 has gotten longer as its corresponding download has progressed.

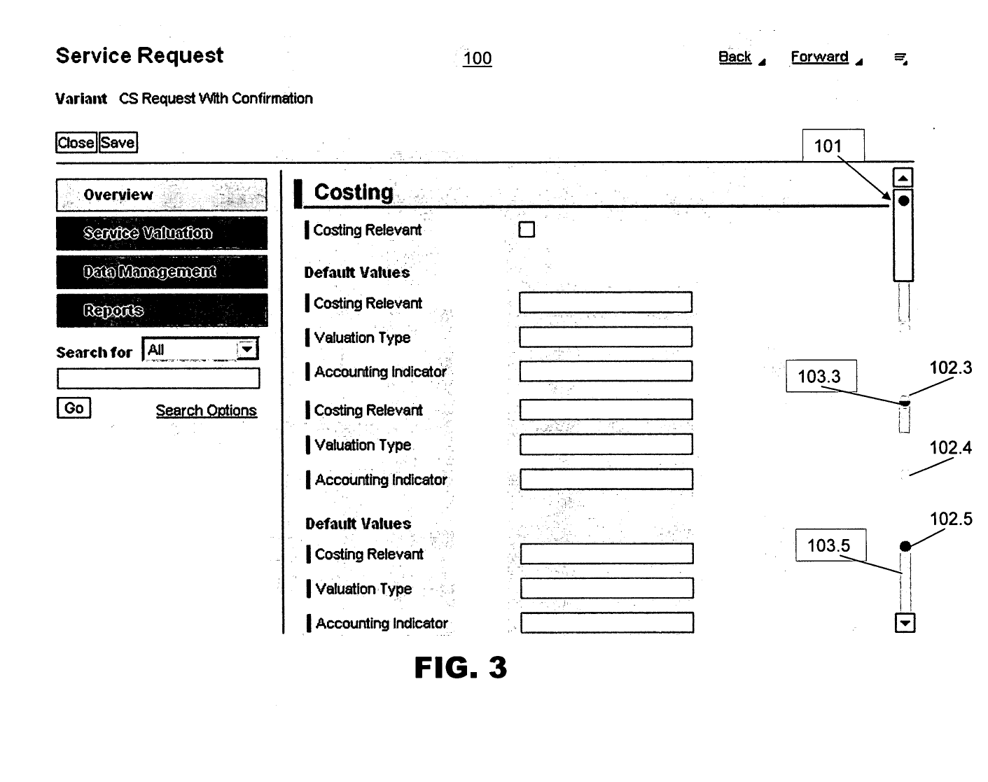

In FIG. 3, indicator 102.5 has become fully dark-colored and status field 103.5 has reached its full extent, indicating that the download of the corresponding document portion is complete. Indicator 102.3 remains partly dark-colored and partly light-colored, showing that the corresponding download is still ongoing. Status field 103.3 has increased in length somewhat as compared to its length in FIG. 2.

The on-demand scrollbar according to embodiments of the present invention may be incorporated into any kind of computer display. Behavior of the display may be governed at least in part by computer-executable instructions according to embodiments of the present invention. The instructions may generate, possibly in association with or by interfacing with conventional code that controls aspects of a display's appearance, a display on a display device, where the display includes an on-demand scrollbar according to embodiments of the invention. The on-demand scrollbar may correspond to an electronic document, which may be displayed concurrently on the display device.

The electronic document may include various tokens, tags, specialized navigation and definitional fields, and the like, defining a navigable structure for the document, in a manner well known in the art. Such fields may be interpreted by the instructions, or by conventional code that interfaces with the instructions, to generate a corresponding distribution of indicators for display in the scrollbar. A distance between indicators may indicate a relative size of a document portion. Thus, how far a download status bar associated with a first indicator has extended toward a second indicator may indicate how close the download of the document portion corresponding to the first indicator is to completing.

Further, the instructions, or conventional code that interfaces with the instructions, may receive input signals from a mouse or other input device and perform corresponding operations. For example, a user may select an indicator 102.1, 102.2, . . . , 102.n by positioning a pointer or cursor or other positional indicator over the indicator 102 and clicking on it. Alternatively, the user may drag the scrolling button 104 to a selected indicator. Such operations may generate selection signals to the instructions, or to conventional code that interfaces with the instructions. In response to the signals, a call or request for a download of the corresponding document portion may be performed.

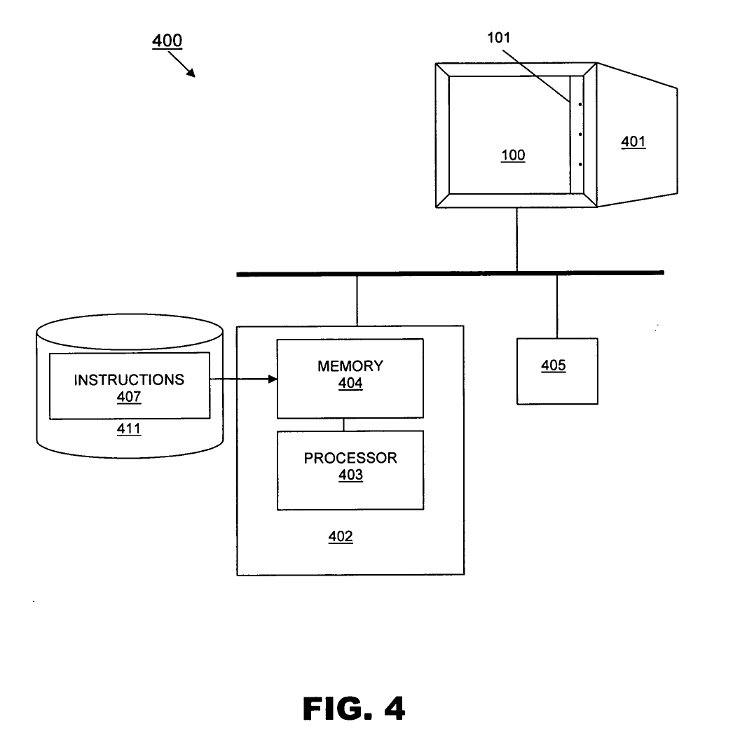

FIG. 4 shows a system 400 wherein embodiments of the present invention may find advantageous application. The system 400 may comprise a display device 401. The display device 401 may be coupled to a computer 402 comprising a processor 403 and memory 404. The computer 402 may further be coupled to an input device 405 such as a mouse or keyboard.

Computer-executable instructions 407 according to embodiments of the may be stored on any machine-readable medium 411, such as RAM (random access memory), ROM (read-only memory), floppy disk, fixed disk, CD-ROM, magnetic tape and the like. The instructions may be loaded from the machine-readable medium 411 into the memory 404 for execution by the processor 403. As noted previously, the instructions may interface with conventional code that controls aspects of a display's appearance.

The instructions 407, or conventional code that interfaces with the instructions 407, may generate a display 100 on the display device 401. The display 100 may include an on-demand scrollbar 101 according to embodiments of the present invention, along with a corresponding electronic document. With the input device 405, a user may activate features of the scrollbar, such as selecting an indicator to initiate download of a corresponding document section. These activities may generate signals from the input device 405 that are detected by the computer 402. The instructions 407, or conventional code that interfaces with the instructions 407, may be responsive to the signals detected by the computer 402 and generate a corresponding display on the display device 401.

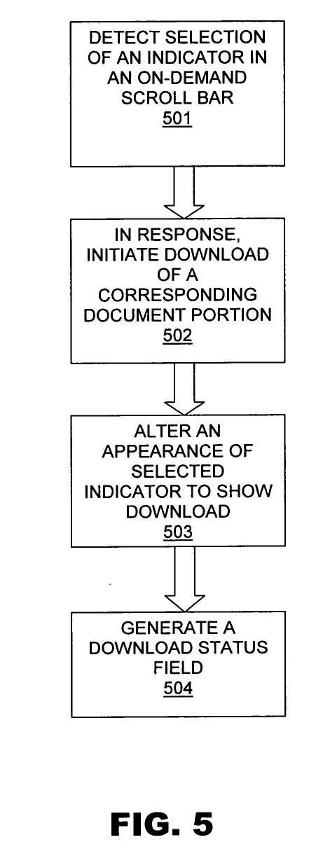

FIG. 5 shows a process flow according to embodiments of the present invention. As shown in block 501, a selection of an indicator in an on-demand scrollbar of a computer display may be detected. The on-demand scrollbar may comprise a plurality of indicators respectively corresponding to portions of an electronic document. In response to detecting the selection, a download of a corresponding document portion may be initiated, as shown in block 502.

Subsequently, an appearance of a selected indicator to show that download of a corresponding document portion is in progress may be altered, as shown in block 503. The alteration in appearance may comprise changing a color of at least a portion of the selected indicator. A download status field associated with a selected indicator may be generated, as shown in block 504.

In embodiments of the invention, a download of all portions of a document may be performed concurrently, i.e. without the user activating download of individual portions. Such a concurrent download could be, for example, activated by loading controls independent of the indicators 102.1-102.n. However, in such a concurrent download, the scrollbar 101 would still track the progress of the download of each document portion as described above, and the other functionality (e.g., stopping and restarting a download of a given portion) discussed above would be available.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method comprising:
generating a display on a display device, the display including an on-demand scrollbar comprising a plurality of indicators respectively corresponding to portions of an electronic document; and
in response to selection of an indicator, initiating a download of a corresponding document portion.

2. The method of claim 1, further comprising altering an appearance of a selected indicator to show that download of a corresponding document portion is in progress.

3. The method of claim 2, wherein the altering of the appearance includes changing a color of at least a portion of the selected indicator.

4. The method of claim 1, further comprising generating a download status field associated with a selected indicator.

5. A machine-readable medium storing instructions to perform a method according to claim 1.

6. A system comprising:
a display device; and
a computer coupled to the display device, the computer to generate a display on the display device, the display including an on-demand scrollbar comprising a plurality of indicators respectively corresponding to portions of an electronic document;
wherein an indicator is responsive to selection thereof to initiate a download of a corresponding document portion.

7. The system of claim 6, further comprising an input device, the input device to generate signals to the computer indicative of the selection.

8. The system of claim 6, wherein each indicator is associated with a download status field.

9. The system of claim 8, wherein a download status field is displayed upon selection of a corresponding indicator.

10. A method comprising:
detecting selection of an indicator in an on-demand scrollbar of a computer display, the on-demand scrollbar comprising a plurality of indicators respectively corresponding to portions of an electronic document; and
in response, initiating a download of a corresponding document portion.

11. The method of claim 10, further comprising altering an appearance of a selected indicator to show that download of a corresponding document portion is in progress.

12. The method of claim 11, wherein the altering of the appearance includes changing a color of at least a portion of the selected indicator.

13. The method of claim 11, further comprising:
generating a download status field associated with a selected indicator.

14. A machine-readable medium storing instructions to perform a method according to claim 10.
